(19) United States
(12) Patent Application Publication
(10) Pub. No.: US 2026/0187152 A1
(43) Pub. Date: Jul. 2, 2026

(54) METHOD, APPARATUS, DEVICE AND STORAGE MEDIUM FOR CONTENT PRESENTATION

(71) Applicant: Beijing Zitiao Network Technology Co, Ltd., Beijing (CN)

(72) Inventors: Zi YE, Beijing (CN); Xinyi LIN, Beijing (CN)

(21) Appl. No.: 19/431,956

(22) Filed: Dec. 23, 2025

(30) Foreign Application Priority Data
Dec. 27, 2024 (CN) 202411960384.1

(51) Int. Cl. G06F 16/903; G06F 16/9038

(52) U.S. Cl. CPC G06F 16/90335; G06F 16/9038

(57) ABSTRACT

Embodiments of the disclosure relate to a method, an apparatus, a device, and a storage medium for content presentation. A method proposed herein includes: obtaining a query request of a user; and presenting a content card associated with a first event in response to the query request matching the first event, the content card including a plurality of items of description content about a plurality of event nodes of the first event, where the plurality of event nodes and the plurality of items of description content are generated by a preset model based on a set of search results associated with the first event.

### CROSS-REFERENCE

The present application claims priority to Chinese Patent Application No. 202411960384.1, filed on Dec. 27, 2024, and entitled “METHOD, APPARATUS, DEVICE AND STORAGE MEDIUM FOR CONTENT PRESENTATION”, which is incorporated herein by reference in its entirety.

### FIELD

Example embodiments of the present disclosure generally relate to the field of computers, and in particular, to a method, an apparatus, a device, and a computer-readable storage medium for content presentation.

### BACKGROUND

With the increasing maturity of network technologies, it has become a daily routine for people to obtain content through network platforms. For example, people may use a network platform to view hot topic content (for example, hot topic events, etc.). In addition, since some hot topic content is related, only by presenting the related hot topic content after aggregation can the viewing needs of users be satisfied. However, the current process of aggregating hot topic content still relies on manual work, which is inefficient.

### SUMMARY

In a first aspect of the present disclosure, a method for content presentation is provided. The method includes: obtaining a query request of a user; and presenting a content card associated with a first event in response to the query request matching the first event, the content card including a plurality of items of description content about a plurality of event nodes of the first event, where the plurality of event nodes and the plurality of items of description content are generated by a preset model based on a set of search results associated with the first event.

In a second aspect of the present disclosure, an apparatus for content presentation is provided. The apparatus includes: an obtaining module configured to obtain a query request of a user; and a presentation module configured to present a content card associated with a first event in response to the query request matching the first event, the content card including a plurality of items of description content about a plurality of event nodes of the first event, where the plurality of event nodes and the plurality of items of description content are generated by a preset model based on a set of search results associated with the first event.

In a third aspect of the present disclosure, an electronic device is provided. The device includes at least one processor; and at least one memory, the at least one memory being coupled to the at least one processor and storing instructions executable by the at least one processor, the instructions, when executed by the at least one processor, causing the device to perform the method of the first aspect.

In a fourth aspect of the present disclosure, a computer-readable storage medium is provided. The computer-readable storage medium has a computer program stored thereon which is executable by a processor to perform the method of the first aspect.

It should be understood that the content described in this summary section is not intended to limit key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1 shows a schematic diagram of an example environment in which the embodiments according to the present disclosure may be implemented;

FIG. 2 shows a flowchart of an example process for content presentation according to some embodiments of the present disclosure;

FIG. 3 shows a schematic diagram of content presentation according to some embodiments of the present disclosure;

FIG. 4 shows a flowchart of an example process of content presentation according to some embodiments of the present disclosure;

FIG. 5 shows a schematic structural block diagram of an example apparatus for content presentation according to some embodiments of the present disclosure; and

FIG. 6 shows a block diagram of an electronic device capable of implementing multiple embodiments of the present disclosure.

### DETAILED DESCRIPTION

The embodiments of the present disclosure will be described in more detail below with reference to the drawings. Although some embodiments of the present disclosure are shown in the drawings, it should be understood that the present disclosure may be implemented in various forms, and should not be interpreted as limited to the embodiments set forth herein. Instead, these embodiments are provided for a more thorough and complete understanding of the present disclosure. It should be understood that the drawings and embodiments of the present disclosure are only for illustrative purposes, and are not intended to limit the protection scope of the present disclosure.

It should be noted that the titles of any section/subsection provided herein are not restrictive. Various embodiments are described throughout this article, and any type of embodiment may be included under any section/subsection. In addition, the embodiments described in any section/subsection may be combined with any other embodiments described in the same section/subsection and/or different section/subsection in any way.

In the description of the embodiments of the present disclosure, the term “include/comprise” and similar terms should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or same objects. Other explicit and implicit definitions may also be included below.

The embodiments of the present disclosure may involve user's data, data acquisition and/or use, etc. These aspects all comply with corresponding laws, regulations and related provisions. In the embodiments of the present disclosure, all data collection, acquisition, processing, machining, forwarding, use, etc. are carried out on the premise that the user knows and confirms. Accordingly, when implementing the embodiments of the present disclosure, the user should be informed of the type, range of use, use scenarios, etc. of data or information that may be involved and the authorization of the user should be obtained in an appropriate manner in accordance with relevant laws and regulations. The specific manner of informing and/or authorizing may vary according to actual situations and application scenarios, and the scope of the present disclosure is not limited in this regard.

If the solutions in this specification and the embodiments involve personal information processing, the processing will be carried out on the premise that there is a legal basis (for example, the consent of the personal information subject is obtained, or it is necessary to perform a contract, etc.), and the processing will only be carried out within the scope of regulations or agreements. If a user refuses to process personal information other than the necessary information required for the basic functions, it will not affect the user's use of the basic functions.

As mentioned above, with the increasing maturity of network technologies, it has become a daily routine for people to obtain content through network platforms. For example, people may use a network platform to view hot topic content (for example, hot topic events, etc.). In addition, since some hot topic content is related, only by presenting the related hot topic content after aggregation can the viewing needs of users be satisfied. However, the existing process of aggregating hot topic content still relies on manual work, which is inefficient.

An embodiment of the present disclosure proposes a solution for content presentation. According to the solution, a query request of a user is obtained; and a content card associated with a first event is presented in response to the query request matching the first event, the content card including a plurality of items of description content about a plurality of event nodes of the first event, where the plurality of event nodes and the plurality of items of description content are generated by a preset model based on a set of search results associated with the first event.

In this way, the embodiment of the present disclosure may determine a plurality of items of description content of a plurality of event nodes of the first event based on a set of search results associated with the first event using a language model in response to the user's query request matching the first event. Moreover, the embodiment of the present disclosure may present a content card generated based on the plurality of items of description content. Therefore, the embodiment of the present disclosure may present the content card associated with the event based on the preset model in response to the query request matching the event, thereby saving human resource consumption and improving the quality and efficiency of content presentation.

Various example implementations of the solution will be described in detail below in conjunction with the drawings.

### Example Environment

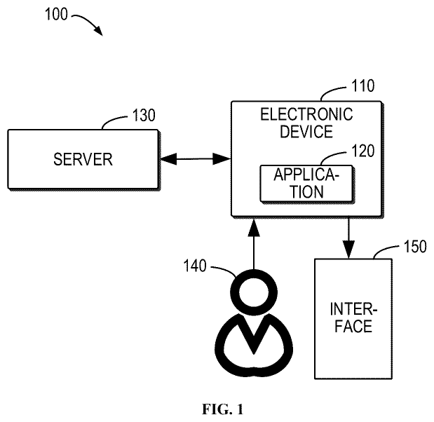

FIG. 1 shows a schematic diagram of an example environment 100 in which the embodiments of the present disclosure may be implemented. As shown in FIG. 1, the example environment 100 may include an electronic device 110.

In the example environment 100, the electronic device 110 may run an application 120 supporting interface interaction. The application 120 may be any appropriate type of application for interface interaction, examples of which may include but be not limited to: a call application, a conference application, a social application, or other appropriate applications. A user 140 may interact with the application 120 via the electronic device 110 and/or its attached device.

In the environment 100 of FIG. 1, if the application 120 is active, the electronic device 110 may present an interface 150 for supporting interface interaction through the application 120.

In some embodiments, the electronic device 110 communicates with a server 130 to implement the provision of services for the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a game device, or any combination thereof, including the fittings and peripherals of these devices or any combination thereof. In some embodiments, the electronic device 110 may also support any type of interface for the user (such as a “wearable” circuit, etc.).

The server 130 may be an independent physical server, a server cluster or a distributed system composed of multiple physical servers, or may be a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 130 may include, for example, a computing system/server, such as a mainframe, an edge computing node, a computing device in a cloud environment, and so on. The server 130 may provide a backstage service for the application 120 supporting a virtual scene in the electronic device 110.

A communication connection may be established between the server 130 and the electronic device 110. The communication connection may be established by a wired or wireless method. The communication connection may include but be not limited to a Bluetooth connection, a mobile network connection, a universal serial bus (USB) connection, a wireless fidelity (WiFi) connection, etc., and the embodiments of the present disclosure are not limited in this regard. In the embodiments of the present disclosure, the server 130 and the electronic device 110 may implement signaling interaction through the communication connection therebetween.

It should be understood that the structure and function of each element in the environment 100 are described only for the purpose of illustration, without implying any limitation on the scope of the present disclosure.

Some example embodiments of the present disclosure will be described below with continued reference to the drawings.

### Example Content Presentation Process

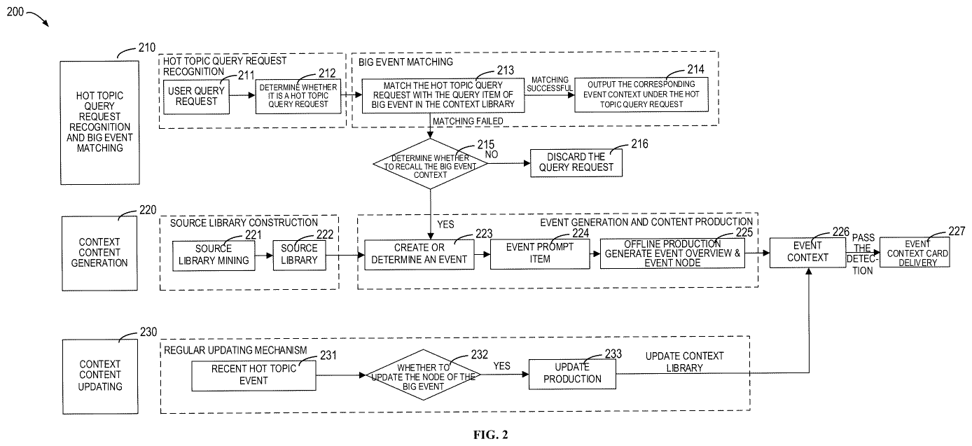

FIG. 2 shows a flowchart of an example process 200 for content presentation according to some embodiments of the present disclosure. The process 200 may be implemented at the electronic device 110 and/or the server 130. The process 200 will be described below with reference to FIG. 1.

In some embodiments, as shown in FIG. 2, content presentation may be divided into three parts, for example, hot topic query request recognition and event matching 210, context content generation 220, and context content updating 230.

As an example, the hot topic query request recognition and event matching 210 is first illustratively introduced.

In some embodiments, at block 211, the electronic device 110 may obtain a query request of a user. Further, at block 212, the electronic device 110 or the server 130 may determine whether the query request is a hot topic query request. As an example, the electronic device 110 or the server 130 may determine a topic of a preset type associated with the query request. For example, the topic of the preset type may include but be not limited to: an economic topic (for example, business activities, market trends, etc.), a cultural topic (for example, art, literature, movies, music, etc.), a science and technology topic (for example, product launch, technological innovation, etc.), etc. Further, the electronic device 110 or the server 130 may determine that the query request is the hot topic query request in response to interaction information of the topic of the preset type associated with the query request satisfying a preset condition. As an example, the interaction information may indicate forwarding data, likes data, comment content, search trends, search indexes, the number of media reports, etc. of the topic of the preset type. The preset condition may, for example, indicate that data associated with the interaction information satisfies a preset threshold, for example, at least one of forwarding volume, likes volume, search index, etc. satisfies the preset threshold.

Additionally, at block 213, the electronic device 110 or the server 130 may determine whether the query request matches a set of candidate events. As an example, the set of candidate events may be stored in a database (or referred to as a context library). For example, the set of candidate events are hot topic events. As an example, the hot topic events may refer to events or topics that are discussed and concerned by users within a specific period of time.

As an example, each candidate event in the set of candidate events may include an event query item. For example, the event query item may include a keyword associated with the candidate event. As an example, the candidate event may be a typhoon event. The keywords associated with the typhoon event may include, for example: heavy rainstorm, typhoon warning, severe typhoon, typhoon risk avoidance, etc.

Additionally or alternatively, the electronic device 110 or the server 130 may determine that a target candidate event is an event associated with the query request (or referred to as a first event) in response to the query request matching at least one event query item in a set of event query items of the target candidate event. As an example, the electronic device 110 or the server 130 may determine that the query request is associated with the typhoon event in response to the query request matching a typhoon warning. At block 214, the electronic device 110 or the server 130 may generate context content associated with the query request and the event in response to the query request matching the event.

Alternatively, at block 215, the electronic device 110 or the server 130 may determine whether to create a second event associated with the query request in response to the query request not matching the set of candidate events. For example, the electronic device 110 or the server 130 may determine to create the second event associated with the query request in response to the query request satisfying a preset condition. As an example, the preset condition may indicate that the query request matches an attribute associated with a hot topic event. For example, the attribute may include a topic type, description content, a person object, an occurrence time, etc. of the hot topic event. As an example, at block 216, the electronic device 110 or the server 130 may determine not to create the second event for the query request in response to the query request not satisfying the preset condition. For example, the electronic device 110 or the server 130 discards the query request.

Alternatively, at block 223, the electronic device 110 or the server 130 may obtain an additional event query item in response to the query request not matching the set of candidate events, to create the second event based on the additional event query item. As an example, the additional event query item may be determined manually or based on a preset model. As an example, the preset model may be a generative model capable of generating event query items (for example, query keywords) based on the query request. The present disclosure is not intended to limit the specific implementation or training process of the generative model.

Next, the context content generation 220 is illustratively introduced. As an example, the context content may include a plurality of event nodes and description content corresponding to the plurality of event nodes.

As an example, the server 130 may carry out construction of a source library. As an example, at block 221, the server 130 may determine at least one content source satisfying a preset condition from a plurality of content sources (or referred to as information sources). As an example, the content source may indicate a news release account (for example, a newspaper office, a personal media user), a news release platform (for example, a news site, a short video platform, etc.), etc. The preset condition may indicate the accuracy of information (for example, news content) provided by the content source. As an example, the accuracy of the information provided by the content source may be confirmed manually or by using a preset model. Further, at block 222, the server 130 may construct the source library based on the at least one content source satisfying the preset condition.

At block 223, the electronic device 110 may determine an event associated with the query request (for example, an event matching the query request or a newly created event).

Additionally, the electronic device 110 or the server 130 may search for at least one content source from the source library based on an event query item associated with the event, to determine a set of search results associated with the event from the at least one content source. As an example, the electronic device 110 may also search for at least one content source from the source library based on the additional event query item associated with the newly created event, to determine a set of search results associated with the second event from the at least one content source. An example description is provided below based on the event associated with the query request.

Additionally or alternatively, at block 225, the electronic device 110 or the server 130 may use a preset model to generate a plurality of event nodes and a plurality of items of description content of the plurality of event nodes based on the set of search results. As an example, at block 226, an event context may be determined based on the plurality of event nodes and/or the plurality of items of content description. Therefore, the event context may indicate the plurality of event nodes and/or the plurality of items of content description in the event.

As an example, at block 224, the preset model may further generate a plurality of event nodes and a plurality of items of description content of the plurality of event nodes based on a preset event prompt item and the set of search results. For example, the event prompt item may indicate a restriction on the event node and the description content of the event node. These restrictions may include, for example, content length (for example, maximum number of characters), keyword filtering, topic range, language style (for example, formal, informal, etc.). As an example, the preset model may be implemented as a generative model (for example, a language model) that generates event nodes and description content based on search results. The present disclosure is not intended to limit the specific implementation or training process of the generative model.

In some embodiments, the description content of the event node may include a title of the event node and/or overview content of the event node.

In some embodiments, the electronic device 110 or the server 130 may determine the content card based on a plurality of items of description content of the plurality of event nodes. As an example, the electronic device 110 or the server 130 may determine a card style (for example, a preset card style), a card recall and ranking policy, a card avoidance policy, a card interaction form, etc. associated with the content card. The present disclosure is not intended to limit the specific implementation process of the card style, the card recall and ranking policy, the card avoidance policy, the card interaction form, etc. Further, the electronic device 110 or the server 130 may support the user to interact with the content card, so as to satisfy further needs of the user (for example, view content details associated with the event node, etc.). As an example, content detection needs to be carried out on the plurality of event nodes and the plurality of items of content description before the content card is delivered. At block 227, the electronic device 110 or the server 130 may delivery the content card in response to the content detection being successful.

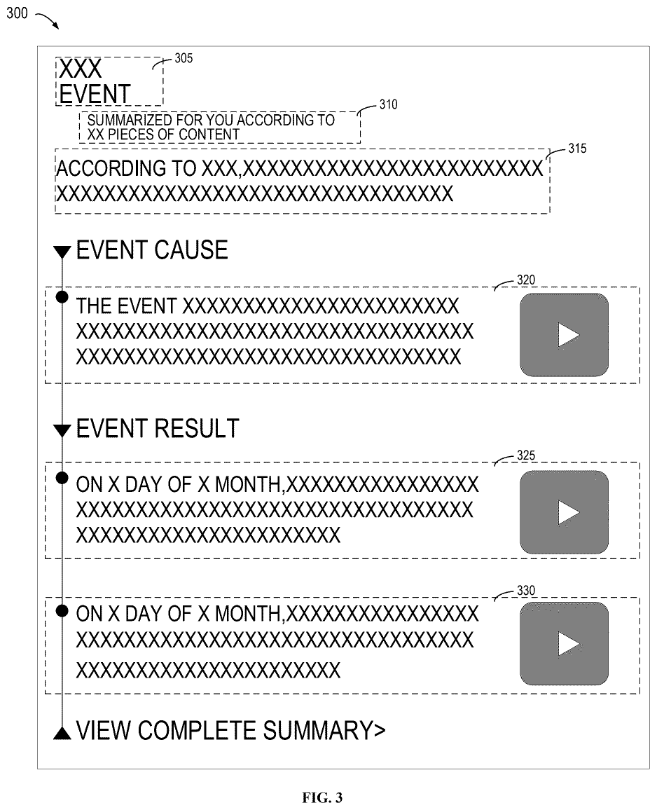

As shown in FIG. 3, FIG. 3 shows a schematic diagram 300 of content presentation according to some embodiments of the present disclosure. The schematic diagram 300 may be provided, for example, by the electronic device 110 shown in FIG. 1.

As shown in FIG. 3, the electronic device 110 may present a content card associated with an event. The electronic device 110 may present an event title 305 (for example, XXX event) of the event in the content card. The electronic device 110 may present source information 310 (for example, “summarized for you according to XX pieces of content”) of the event in the content card. The electronic device 110 may present overview content 315 of the event in the content card. The electronic device 110 may present a plurality of event nodes in the content card. The plurality of event nodes may include a first event node 320, a second event node 325, and a third event node 330. For example, the electronic device 110 may also present overview content and/or image content associated with the first event node 320 in the content card. As an example, a title corresponding to the first event node 320 is, for example, “event impact”. Titles corresponding to the second event node 325 and the third event node 330 are, for example, “investigation result”.

As an example, the content card may be configured to present a plurality of items of description content based on a chronological order of the plurality of event nodes. For example, the electronic device 110 or the server 130 may determine that a display position of the second event node 325 in the content card is higher than a display position of the third event node 330 based on a first time of the second event node 325 being later than a second time of the third event node 330.

Additionally, the electronic device 110 may present additional content associated with at least one event node in response to receiving a selection of the at least one event node in the plurality of event nodes. As an example, the additional content may include a content source, original event content description, image content, etc. associated with the at least one event node. For example, the electronic device 110 may present additional content of the third event node 330 in response to receiving a trigger on the third event node 330. As an example, the electronic device 110 may also present a hidden event node in the content card in response to receiving a viewing request (for example, view a complete summary) for the content card.

Continuing to refer to FIG. 2, the context content generation 220 is illustratively introduced.

As an example, the plurality of event nodes and/or the plurality of items of description content associated with the event may be periodically generated by the preset model. As an example, the electronic device 110 or the server 130 may generate a new event node and/or description content associated with the event using the preset model based on new search results that are obtained in response to the event not being updated for a preset duration (for example, a week).

For example, at block 231, the electronic device 110 or the server 130 may determine whether to update an event node of the event in response to the event being a hot topic event recently (for example, within a preset period of time, for example, within the last three days). As an example, the electronic device 110 or the server 130 may determine whether the event is the hot topic event within the preset period of time based on interaction information associated with the event. Further, at block 232, the electronic device 110 or the server 130 may determine a set of updated search results obtained based on an event query item associated with the event in response to determining to update the event node of the event. Further, at block 233, the electronic device 110 or the server 130 may generate a new event node and/or description content associated with the event based on the set of updated search results. Further, the electronic device 110 or the server 130 may update the database (or referred to as the context library) based on the new event node and/or the description content, to determine a new event context associated with the event.

In this way, embodiments of the present disclosure are capable of determining a plurality of items of description content of a plurality of event nodes of the event based on a set of search results associated with the event using the preset model in response to the user's query request matching the event. Moreover, embodiments of the present disclosure are capable of presenting a content card generated based on the plurality of items of description content. Therefore, embodiments of the present disclosure are capable of presenting the content card associated with the event based on the preset model in response to the query request matching the event, thereby saving human resource consumption and improving the quality and efficiency of content presentation. In addition, embodiments of the present disclosure are also capable of updating the event periodically, further improving the efficiency of content presentation.

### Example Process

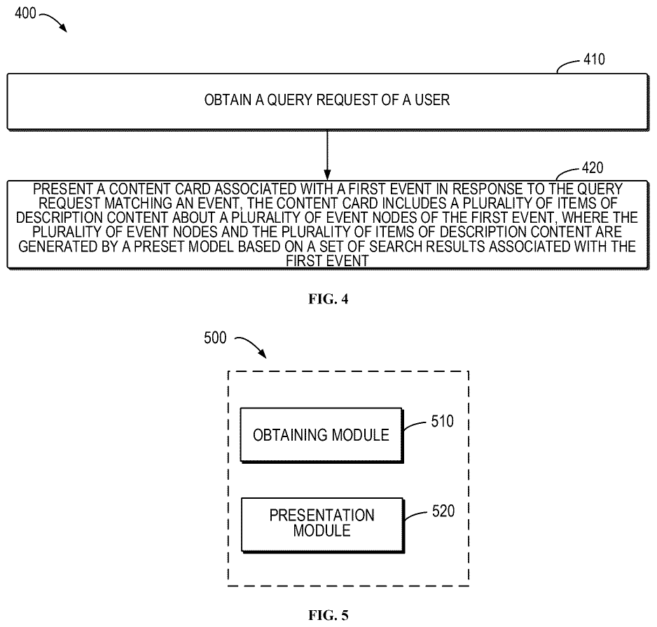

FIG. 4 shows a flowchart of an example process 400 of content presentation according to some embodiments of the present disclosure. The process 400 may be implemented at the electronic device 110. The process 400 will be described below with reference to FIG. 1.

As shown in FIG. 4, at block 410, the electronic device 110 obtains a query request of a user.

At block 420, the electronic device 110 presents a content card associated with a first event in response to the query request matching the first event, the content card includes a plurality of items of description content about a plurality of event nodes of the first event, where the plurality of event nodes and the plurality of items of description content are generated by a preset model based on a set of search results associated with the first event.

In some embodiments, the query request is determined to match the first event based on the following process: determining whether the query request matches a set of event query items in response to determining that the query request is associated with a topic of a preset type, the set of event query items being associated with the first event; and determining that the query request matches the first event in response to the query request matching at least one event query item.

In some embodiments, interaction information of the topic of the preset type satisfies a preset condition.

In some embodiments, the process 400 further includes: obtaining an additional event query item in response to the query request not matching a set of candidate events, to create a second event based on the additional event query item.

In some embodiments, the set of search results is determined based on the following process: determining at least one content source; and searching the at least one content source based on an event query item associated with the first event, to determine the set of search results.

In some embodiments, the plurality of event nodes and/or the plurality of items of description content are periodically generated by the preset model.

In some embodiments, the content card is configured to present the plurality of items of description content based on a chronological order of the plurality of event nodes.

In some embodiments, the description content of the event node indicates at least one of the following: a title of the event node; and overview content of the event node.

In some embodiments, the process 400 further includes: presenting additional content associated with at least one event node in response to receiving a selection of the at least one event node in the plurality of event nodes.

### Example Apparatuses and Devices

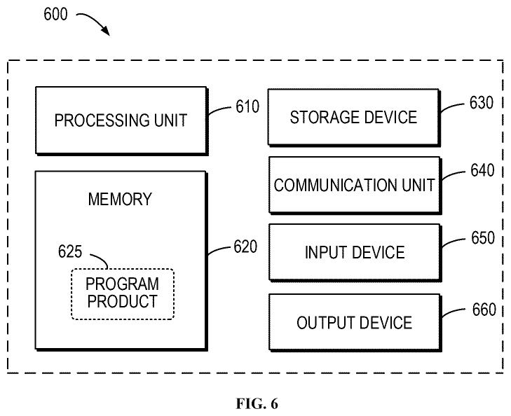

The embodiments of the present disclosure further provide corresponding apparatuses for implementing the above methods or processes. FIG. 5 shows a schematic structural block diagram of an example apparatus 500 for content presentation according to some embodiments of the present disclosure. The apparatus 500 may be implemented as or included in the electronic device 110. Each module/component in the apparatus 500 may be implemented by hardware, software, firmware, or any combination thereof.

As shown in FIG. 5, the apparatus 500 includes: an obtaining module 510 configured to obtain a query request of a user; and a presentation module 520 configured to present a content card associated with a first event in response to the query request matching the first event, the content card includes a plurality of items of description content about a plurality of event nodes of the first event, where the plurality of event nodes and the plurality of items of description content are generated by a preset model based on a set of search results associated with the first event.

In some embodiments, the query request is determined to match the first event based on the following process: determining whether the query request matches a set of event query items in response to determining that the query request is associated with a topic of a preset type, the set of event query items being associated with the first event; and determining that the query request matches the first event in response to the query request matching at least one event query item.

In some embodiments, interaction information of the topic of the preset type satisfies a preset condition.

In some embodiments, the apparatus 500 further includes a creation module, the creation module is configured to obtain an additional event query item in response to the query request not matching a set of candidate events, to create a second event based on the additional event query item.

In some embodiments, the set of search results is determined based on the following process: determining at least one content source; and searching the at least one content source based on an event query item associated with the first event, to determine the set of search results.

In some embodiments, the plurality of event nodes and/or the plurality of items of description content are periodically generated by the preset model.

In some embodiments, the content card is configured to present the plurality of items of description content based on a chronological order of the plurality of event nodes.

In some embodiments, the description content of the event node indicates at least one of the following: a title of the event node; and overview content of the event node.

In some embodiments, the apparatus 500 further includes an additional content module, the additional content module is configured to present additional content associated with at least one event node in response to receiving a selection of the at least one event node in the plurality of event nodes.

The modules included in the apparatus 500 may be implemented in various ways, including software, hardware, firmware, or any combination thereof. In some embodiments, one or more units may be implemented using software and/or firmware, for example machine executable instructions stored on a storage medium. In addition to machine executable instructions or as an alternative, some or all modules in the apparatus 500 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and so on.

FIG. 6 shows a block diagram of an electronic device 500 in which one or more embodiments of the present disclosure may be implemented. It should be understood that the electronic device 600 shown in FIG. 6 is only illustrative, and should not constitute any limitation on the function and scope of the embodiments described herein. The electronic device 600 may be used to implement the electronic device 110 in FIG. 1.

As shown in FIG. 6, the electronic device 600 is in the form of a general electronic device. The components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and may execute various processing based on the programs stored in the memory 620. In a multi-processor system, a plurality of processing units execute computer executable instructions in parallel to improve the parallel processing capability of the electronic device 600.

The electronic device 600 typically includes multiple computer storage medium. Such medium may be any available medium that is accessible by the electronic device 600, including but not limited to volatile and non-volatile medium, removable and non-removable medium. The memory 620 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 630 may be any removable or non-removable medium, and may include a machine-readable medium such as a flash drive, a disk, or any other medium, which may be used to store information and/or data and may be accessed within the electronic device 600.

The electronic device 600 may further include additional removable/non-removable, volatile/non-volatile memory medium. Although not shown in FIG. 6, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 620 may include a computer program product 625, which has one or more program modules configured to perform various methods or acts of the various embodiments of the present disclosure.

The communication unit 640 enables communication with other electronic devices via the communication medium. Additionally, the functions of the components of the electronic device 600 may be implemented by a single computing cluster or multiple computing machines, which may communicate through communication connections. Therefore, the electronic device 600 may use a logical connection with one or more other servers, a network personal computer (PC) or another network node to operate in a networked environment.

The input device 650 may be one or more input devices, such as a mouse, a keyboard, a tracking ball, etc. The output device 660 may be one or more output devices, such as a display, a speaker, a printer, etc. The electronic device 600 may also communicate with one or more external devices (not shown) such as a storage device, a display device, etc., as needed via the communication unit 640, communicate with one or more devices that enable the user to interact with the electronic device 600, or communicate with any devices (for example, a network card, a modem, etc.) that enable the electronic device 600 to communicate with one or more other electronic devices. Such communication may be performed via input/output (I/O) interfaces (not shown).

According to an example implementation of the present disclosure, there is provided a computer-readable storage medium having computer-executable instructions stored thereon, where the computer-executable instructions are executed by a processor to implement the method described above. According to an example implementation of the present disclosure, there is further provided a computer program product tangibly stored on a non-transitory computer-readable medium and including computer-executable instructions, the computer-executable instructions being executed by a processor to implement the method described above.

Various aspects of the present disclosure are described herein with reference to flowcharts and/or block diagrams of methods, apparatuses, devices, and computer program products implemented according to the present disclosure. It should be understood that each block of the flowchart and/or block diagram, and combinations of blocks in the flowchart and/or block diagram, may be implemented by computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, create an apparatus for implementing the functions/acts specified in one or more blocks of the flowchart and/or block diagram. These computer-readable program instructions may also be stored in a computer-readable storage medium, these instructions cause the computer, the programmable data processing apparatus, and/or other devices to work in a specific manner, so that the computer-readable medium storing the instructions includes a manufactured product, which includes instructions for implementing various aspects of the functions/acts specified in one or more blocks of the flowchart and/or block diagram.

The computer-readable program instructions may be loaded onto a computer, another programmable data processing apparatus, or other devices, such that a series of operation steps are performed on the computer, the another programmable data processing apparatus, or the other devices to produce a computer-implemented process, so that the instructions executed on the computer, the another programmable data processing apparatus, or the other devices implement the functions/acts specified in one or more blocks of the flowchart and/or block diagram.

The flowchart and block diagram in the drawings show the possibly implemented architectures, functions, and operations of the system, method, and computer program product according to multiple implementations of the present disclosure. In this regard, each block in the flowchart or block diagram may represent a module, a program segment, or a portion of instructions, and the module, the program segment, or the portion of instructions contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and the combination of the blocks in the block diagram and/or the flowchart may be implemented by a special-purpose hardware-based system that executes specified functions or acts, or may be implemented by a combination of special-purpose hardware and computer instructions.

The implementations of the present disclosure have been described above, and the above description is example, non-exhaustive, and not limited to the disclosed implementations. Without departing from the scope of the illustrated implementations, many modifications and changes will be apparent to those of ordinary skill in the art. The terms used herein are chosen to best explain the principles of the implementations, the practical applications or improvements to the technology in the market, or to enable other those of ordinary skill in the art to understand the implementations disclosed herein.

1. A method for content presentation, comprising:
obtaining a query request of a user; and
presenting a content component associated with a first event in response to the query request matching the first event, the content component comprising a plurality of items of description content about a plurality of event nodes of the first event, wherein the plurality of event nodes and the plurality of items of description content are generated by a preset model based on a set of search results associated with the first event.

2. The method of claim 1, wherein the query request is determined to match the first event based on the following process:
determining whether the query request matches a set of event query items in response to determining that the query request is associated with a topic of a preset type, the set of event query items being associated with the first event; and
determining that the query request matches the first event in response to the query request matching at least one event query item.

3. The method of claim 2, wherein interaction information of the topic of the preset type satisfies a preset condition.

4. The method of claim 2, further comprising:
obtaining an additional event query item in response to the query request not matching a set of candidate events, to create a second event based on the additional event query item.

5. The method of claim 1, wherein the set of search results is determined based on the following process:
determining at least one content source; and
searching the at least one content source based on an event query item associated with the first event, to determine the set of search results.

6. The method of claim 1, wherein the plurality of event nodes and/or the plurality of items of description content are periodically generated by the preset model.

7. The method of claim 1, wherein the content component is configured to present the plurality of items of description content based on a chronological order of the plurality of event nodes.

8. The method of claim 1, wherein the description content of the event node indicates at least one of the following:
a title of the event node; and
overview content of the event node.

9. The method of claim 1, further comprising:
presenting additional content associated with at least one event node in response to receiving a selection of the at least one event node in the plurality of event nodes.

10. An electronic device, comprising:
at least one processor; and
at least one memory, the at least one memory being coupled to the at least one processor and storing instructions executable by the at least one processor, the instructions, when executed by the at least one processor, causing the electronic device to perform operations comprising:
obtaining a query request of a user; and
presenting a content component associated with a first event in response to the query request matching the first event, the content component comprising a plurality of items of description content about a plurality of event nodes of the first event, wherein the plurality of event nodes and the plurality of items of description content are generated by a preset model based on a set of search results associated with the first event.

11. The electronic device of claim 10, wherein the query request is determined to match the first event based on the following process:
determining whether the query request matches a set of event query items in response to determining that the query request is associated with a topic of a preset type, the set of event query items being associated with the first event; and
determining that the query request matches the first event in response to the query request matching at least one event query item.

12. The electronic device of claim 11, wherein interaction information of the topic of the preset type satisfies a preset condition.

13. The electronic device of claim 11, wherein the operations further comprise:
obtaining an additional event query item in response to the query request not matching a set of candidate events, to create a second event based on the additional event query item.

14. The electronic device of claim 10, wherein the set of search results is determined based on the following process:
determining at least one content source; and
searching the at least one content source based on an event query item associated with the first event, to determine the set of search results.

15. The electronic device of claim 10, wherein the plurality of event nodes and/or the plurality of items of description content are periodically generated by the preset model.

16. The electronic device of claim 10, wherein the content component is configured to present the plurality of items of description content based on a chronological order of the plurality of event nodes.

17. The electronic device of claim 10, wherein the description content of the event node indicates at least one of the following:
a title of the event node; and
overview content of the event node.

18. The electronic device of claim 10, wherein the operations further comprise:
presenting additional content associated with at least one event node in response to receiving a selection of the at least one event node in the plurality of event nodes.

19. A non-transitory computer-readable storage medium having a computer program stored thereon, the computer program being executable by a processor to perform operations comprising:
obtaining a query request of a user; and
presenting a content component associated with a first event in response to the query request matching the first event, the content operations comprising a plurality of items of description content about a plurality of event nodes of the first event, wherein the plurality of event nodes and the plurality of items of description content are generated by a preset model based on a set of search results associated with the first event.

20. The non-transitory computer-readable storage medium of claim 19, wherein the query request is determined to match the first event based on the following process:
determining whether the query request matches a set of event query items in response to determining that the query request is associated with a topic of a preset type, the set of event query items being associated with the first event; and
determining that the query request matches the first event in response to the query request matching at least one event query item.
